(19) United States
(12) Patent Application Publication
(10) Pub. No.: US 2006/0091670 A1
(43) Pub. Date: May 4, 2006

(54) Method for ensuring authenticity of beauty products

(76) Inventor: Lawrence D. Gaynor, West Bloomfield, MI (US)

Correspondence Address: DYKEMA GOSSETT PLLC, SUITE 300, 39577 WOODWARD AVENUE, BLOOMFIELD HILLS, MI, 48304, US

(21) Appl. No.: 11/266,150

(22) Filed: Nov. 3, 2005

Related U.S. Application Data
(60) Provisional application No. 60/624,743, filed on Nov. 3, 2004.

(51) Int. Cl. B42D 15/00

(52) U.S. Cl. 283/81

(57) ABSTRACT

The present invention is a method for ensuring that authentic beauty products are supplied to salon retailers and consumers. In particular, the present invention related to a method of providing a label on a product that certifies the genuineness of the product, thereby reassuring the salon retailer and consumer that they are purchasing a genuine product that has been guaranteed for authenticity. Specifically, the present invention may include the steps of obtaining the beauty product from the original manufacturer and ensuring the authenticity of the article throughout the subsequent channels of trade, wherein the products are ultimately provided identified with an authenticity label which guarantees to the consumer that they are purchasing a genuine product.

This application claims priority to U.S. Provisional Application Ser. No. 60/624,743 filed Nov. 3, 2004, which is incorporated by reference in its entirety.

### FIELD OF THE INVENTION

The present invention relates to a method for ensuring that authentic beauty products are supplied to salon retailers. In particular, the present invention relates to a method of product distribution and labeling that certifies the genuineness of the product, thereby reassuring the salon retailer and consumer that they are purchasing a genuine product that has been guaranteed for authenticity.

### BACKGROUND OF THE INVENTION

Within various areas of commerce, there is a concern of purchasing goods that are not genuine but are being held out by various distributors and retailers as being authentic. Such goods have either been diverted through various channels of trade to non-authorized dealers, or have entered the country as “gray-market imports”. Gray market goods refer to foreign manufactured goods having a valid US trademark that are legally purchased abroad but are then imported into the United States without the consent of the US trademark holder. The entry of the goods into the market dilutes goods that are being provided by authorized distributors and retailers. A further frustration relates to the manufacturing of counterfeit goods that compete within the market with the genuine brands. The counterfeit goods often exhibit the same packaging and appearance as the original goods, therefore adding to the confusion of the consumer. The counterfeit and diverted goods unfairly compete with the goods of authorized retailers, and may not meet the quality standards that consumers have come to expect under the product's brand names.

Counterfeit and gray market activity has particularly been an issue in the beauty salon industry, where products intended to be sold exclusively at beauty salons have made their way into grocery stores and drug stores. The beauty industry often desires to be able to ensure to its customers that the various products that they are purchasing at a salon retail establishment are of a higher quality than those products sold in a drug store or grocery store chain.

Different tracking systems have been created to ensure that authentic products are provided within the market. Many tracking systems require the use of bar codes and scanner systems to ensure that authentic goods are being purchased by retailers and consumers. These systems are cumbersome and are very labor intensive, as well as expensive. In particular, one tracking system includes the use of a watermark and a unique identification code associated with each entity, wherein the watermark allows for the tracking, tracing and authentication of the object with a tracking system, see US Publication No. 2003/0179902, Ambrogio et al. entitled “Authentication and Anti-Counterfeit Tracking System. Similarly, U.S. Pat. No. 4,558,318, Katz et al, entitled “Merchandise Verification and Information System”, provides a system for tracing units of merchandise having authentication devices or tags having a machine-readable identification number. Additionally, various labels may be used to establish authenticity as provided in US Publication No. 2004/0151880, Nakamura et al., entitled “Recording Matter Having Countermeasure Against Forgery” and U.S. Pat. No. 6,241,289, Kulper et al., entitled “Laser Labels and Their Use”. Although it is necessary to create somewhat of a “tracking” system in order to ensure that genuine goods are entering the stream of commerce, the costs and complexity of the various systems need to be taken into consideration. One problem with these various “tracking” systems is that they are expensive and require different types of networking and technology. Therefore, it may be desirable to provide a method of conducting sales that provides assurances to the retailers and consumers that they are receiving authentic goods in which they can rely on for certain quality characteristics in a cost effective manner. Furthermore, it may be desirable to provide a simple and cost effective method for ensuring that all products are from a legitimate source and maintain a certain standard of quality. Lastly, it may be desirable to create a system that is flexible and can be customized according to the needs of the clientele.

As with many different industries, the beauty product industry has been impacted by the sale of non-genuine goods to various retailers, which includes various drug stores and grocery store chains. Moreover, there is a need in the beauty industry for a cost effective but efficient method for tracking the authenticity of products. In many instances, the retailers and consumers are not aware that they are purchasing non-genuine goods. This type of activity diminishes retailer and consumer confidence in the products, and ultimately in the distributors that are providing these products. Furthermore, various salon establishments are losing out on profits due to consumers thinking that they can purchase genuine products at non-salon retail establishments. Therefore, there is a continuous need for ensuring that the salon retailers are obtaining genuine products from their distributors and manufacturers, and that these products have been guaranteed for a particular level of quality. Similarly, it is necessary for consumers to be able to have confidence in the quality and genuineness of the products they are purchasing from salon establishments.

### SUMMARY OF THE INVENTION

The present invention is a method for ensuring that authentic beauty products are supplied to salon retailers and consumers. In particular, the present invention relates to a method of providing a label on a product that certifies the genuineness of the product, thereby assuring the salon retailer and consumer that they are purchasing a genuine product that has been guaranteed for authenticity. Specifically, the present invention includes the step of obtaining the beauty product from the original manufacturer and ensuring the authenticity of the article throughout the subsequent channels of trade. The manufacturer provides the beauty product to the distributor for packaging and distribution out into the marketplace. The distributor receives the products and places an authenticity label on the article to verify origination and guarantee genuineness. The products having the authenticity label are then provided to the salon retailers for sale to consumers. The participating salons may further request that the authenticity labels include various design logos unique to each of the salons thereby providing identification information which is customized per the salons request.

In another embodiment, the labels and products may be provided to the salon retailers separately by the distributor thereby allowing the salons to put their own authenticity labels on the product. Moreover, various posters, signs and display pieces are provided to the salon retailers as sales and advertising materials in order to notify consumers that genuine articles are sold at the salon establishment. Each of these methods ensure that genuine articles are being distributed to salon retailers and consumers, and further provide a heightened sense of awareness of the quality and genuineness of the products being sold within a salon retail establishment.

### BRIEF DESCRIPTION OF THE DRAWINGS

FIG. 1 is flow chart providing an embodiment of the present invention;

FIG. 2 is a flow chart providing another embodiment of the present invention;

FIG. 3 is a flow chart providing another embodiment of the present invention;

FIG. 4a is a plan view of an authenticity label as provided by the present invention;

FIG. 4b is a plan view of another embodiment of an authenticity label as provided by the present invention; and

FIG. 5 is a plan view of a exemplary piece of advertising material as provided by the present invention.

### DETAILED DESCRIPTION OF EMBODIMENTS OF THE INVENTION

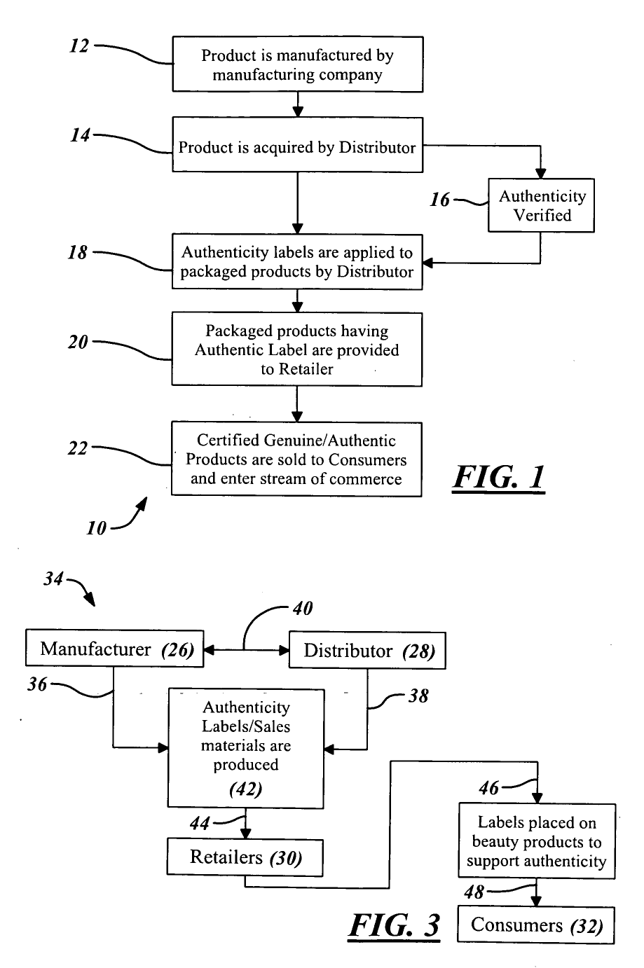

Referring now to the drawings wherein like reference numerals are used to identify identical steps in the various charts, FIG. 1 is a flow chart providing a method 10 for ensuring the authenticity of beauty products from its origination with a manufacturer to its use with a consumer. Beauty products may include, but are not limited to, various lotions, hair products, nail products, or other items that fall within the general scope of beauty and personal hygiene. In particular, the present invention may be directed towards those beauty products that are exclusively salon beauty products and should only be sold within authorized salon retail establishments. The ability to ensure and communicate the authenticity of products from the manufacturer to the consumer may be a multi-stage process. In a first step 12, the product may be manufactured by the original manufacturing company. In a next step 14, the manufacturing company may then provide a genuine article to a distributor for packaging and distribution throughout the marketplace. The marketplace further includes various salon retail establishments that are authorized to sell salon quality products. Manufacturers may include various sized corporations to small scale family businesses that do not have the capabilities of distributing their own product. Similarly, distributors may be regional or localized companies that distribute various manufacturers' products to beauty salon establishments.

After the product is acquired by the distributor, a next step 16 is to verify authenticity of the products. In order to verify authenticity, the distributor may conduct various verification activities, that may include but are not limited to, analytical testing or looking to documentation establishing a verifiable chain of possession. Such verification process may provide the foundation for certification of the authenticity of the product. Although analytical testing may be expensive, it is only one of the possible ways to determine the authenticity or genuineness of an article. Another method of verification includes a process where the goods themselves are not tested for authenticity but instead their genuineness is determined by the receiving of the products in sealed cases directly from the manufacturer. A bill of lading, or other type of delivery documentation, states the manufacturer's name and shipping point, thereby supporting a claim of authenticity. In general, products are not accepted for distribution by the distributors unless they are directly shipped from the manufacturer and received by the distributor. A continuous chain of title is established from the manufacturer to the distributor, thereby ensuring the distributor that they are receiving genuine salon grade products that can be provided to the beauty salon establishments.

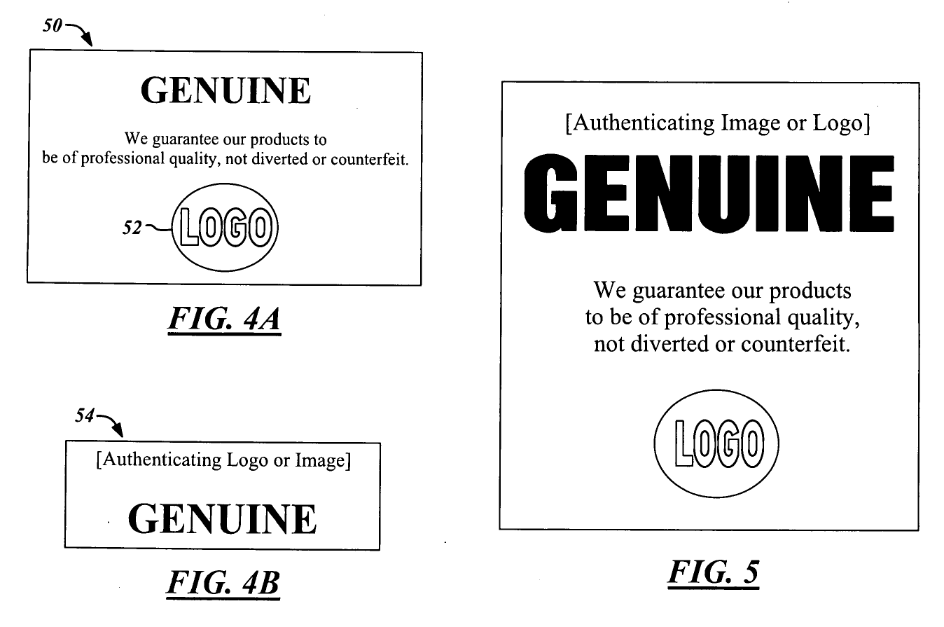

Following the verification step 16, next step 18 may be to apply labels. Labels (such as labels shows in FIGS. 4A and 4B), may be applied by the distributor automatically in order to visually communicate that authenticity of the product has been certified. Various stylized authenticating labels may be applied to the products depending on the nature of the containers or depending on the requests of the beauty salons where the products will be sold. In a next step 20, the packaged products having the authenticity labels are then provided to the salon retailers for sale to the end customers. Once the labeled genuine products are provided to the retailers, in a next step 22 they are sold to the consumers.

Another method of assuring consumers that they are purchasing genuine beauty products, is by the distributor providing various advertising and educational materials to the salons to display within the salon establishments. Such materials may explain the authenticity/verification program and may further inform the salon clientele about the authenticity of the beauty products. The advertising materials include various posters, stickers, display panels, information cards, and other related advertising materials that are supplied to the salon retailers from the distributors. These materials allow the various salons to advertise to the customers that they are authorized dealers of authentic beauty products and that the customer is guaranteed to be purchasing genuine beauty products of high end quality and performance. Furthermore the advertisements suggest that the goods are not diverted or counterfeit and therefore further inform the consumers that other goods that they see out in the marketplace without the authenticity labels could potentially be counterfeit or diverted goods from gray markets. The advertising program encourages consumers to be more aware of the beauty products they are purchasing and allows the salons to communicate with the clientele about the products that they sell and the steps that are taken to ensure that the products are in fact guaranteed to be authentic salon grade beauty products.

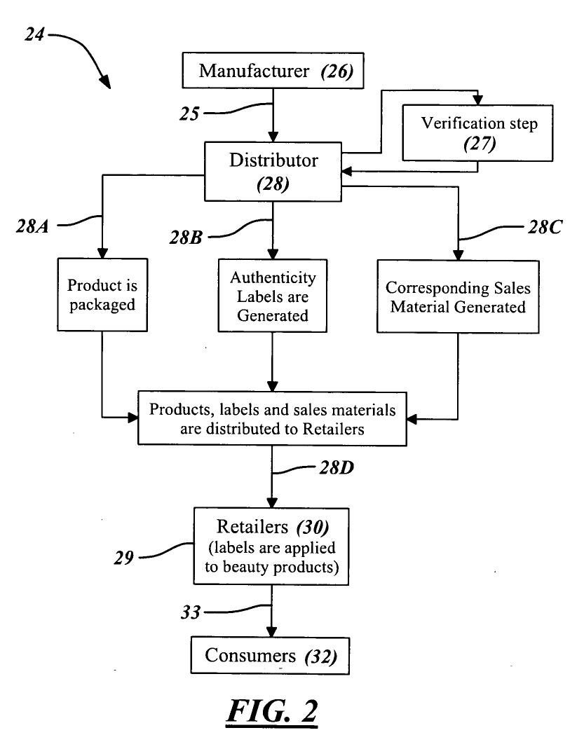

Another method 24 for providing authentic beauty products into the stream of commerce, is provided in FIG. 2. In particular, in a step 25, the manufacturer 26 may provide the products to the distributor 28 for sale and distribution to various salon retailers 30. The distributor 28 acquires the beauty products in bulk quantities and individually packages them for sale in a step 28A. Prior to individually packaging the beauty products, the distributor in a step 27 verifies the authenticity of the bulk beauty products, as previously described in relation to FIG. 1. The packaging used may be unique to each of the various salon retailers to which the distributor provides authentic salon quality products. In addition, in a step 28B, the distributor 28 may generate authenticity labels to be placed on the individually packaged beauty products that have already been checked for authenticity. As previously described, in a step 28C corresponding sales and advertising materials, which may include but are not limited to posters, fliers, and stickers, are generated that reflect the information provided on the authenticity labels. This type of information can be made to include various slogans or logos of the corresponding beauty salons for incorporation in the sales information and display items. In particular, the posters may be displayed within the salon retailers to advertise to the consumers that they are in fact selling genuine products that have a guaranteed authenticity. The corresponding sales materials provided in step 28C are produced by the distributor 28 and may be used to reaffirm to the consumers 32 that the retailer 30 is an authorized dealer of authentic beauty products and that the genuineness of the products has been verified. Furthermore, the corresponding materials may be used to educate the consumer 32 about the steps taken to guarantee the authenticity of beauty products. Following the product packaging in step 28A, generation of the authenticity labels in step 28B, and creating the sales materials in step 28C, all of the materials may be provided to the individual retailers 30 for their sale and distribution in a step 28D. In the next step 29, the retailers 30 then apply the authenticity labels to the products thereby certifying and guaranteeing their genuineness to their consumers 32 as the products are provided to the consumers in next step 33.

A third embodiment 34 is provided in FIG. 3, wherein the manufacturer 26 and the distributor 28 individually may provide products to retailers 30, in steps 36 and 38, respectively. Additionally, in a step 40, the manufacturer 26 and distributor 28 may simultaneously supply each other with products for use in the market. In a step 42, authenticity labels and corresponding sales materials may be produced by both the manufacturer 26 and distributor 28, respectively, depending on the needs of the particular retailers 30 that they are working with. In a next step 44, the authenticity labels and products are then supplied to the retailers 30, and in a subsequent step 46, the retailers 30 place the corresponding labels on the products to guarantee authenticity. Ultimately, the products having the authenticity labels are sold to the consumers 32 in a step 48, thereby guaranteeing their genuineness.

In each of the FIGS. 1-3, a continued chain of possession or documentation thereby confirming the actual authenticity of the products may be established through a variety of ways. As previously provided, direct shipping from the manufacturer to the distributor supports the assertion that authentic products are being sold. The authenticity labels are provided to reassure the consumer that they are purchasing a genuine article that has been continuously monitored for authenticity and quality.

One particular example of the present method being applied relates to a beauty supply manufacturer that produces various nail care products. Such products are then provided to a nail care product distributor that serves as a intermediary between the manufacturer and the salons. The nail care distributor receives the manufacturers products and contacts each of the salons that provide nail services and may have an interests in the provided products. The various retailers may include salons that operate nationwide, or small scale operations, such as individually owned salons that are local to a particular area. The method of the present invention can be modified depending on the needs of the various salons and the distributors and manufacturers that are involved. Furthermore, the authentication process and system may be modified depending on the type of products that are being sold to the salons. Although the present invention is primarily targeted to apply to beauty salons, various other exclusive retailers that sell any type of beauty and personal hygiene products may incorporate the provided authenticity labeling system in order to assure their consumers that they are purchasing genuine beauty products.

The authenticity label can take many different forms and have various embodiments, such as those provided in FIGS. 4a and 4b. As can be seen in FIG. 4a, one embodiment of the authenticity label 50 certifies the authenticity of the article. Furthermore the label provides a detailed explanation of what the authenticity label's purpose is, in particular “We guarantee our products to be of profession quality, not diverted or counterfeit”. Such verification of authenticity may be phrased in different forms and this particular language is not intended to limit the scope of the authenticity label, but to merely provide one embodiment of the authenticity label. Additionally the authenticity label 50 can provide the logo 52 of the retailer 30, thereby personalizing the labels 50 for each of the retailers 30. The addition of the logo 52 allows the retailers 30 to know that the products that they are obtaining are genuine and specific to their particular business. The authenticity label 50 may be reconfigured to meet the needs of the specific salon retailer 30 and can include various types of other information that the salon retailer 30 would like to provide to the consumers 32. Such information may include, but is not limited to: phone numbers of the retailers, distributors, or manufacturers; email addresses; or various other types of contact information that need to be conveyed to the consumers. Furthermore, various contact information, i.e. email and telephone numbers, may be provided on the authenticity label to allow consumers to contact the distributor if there is any reason that the consumer believes that they have purchased a salon product having an authenticity label, that may not in fact be genuine. The authenticity label may further include a holographic image that is unique to the product and prevents the label from being copied.

A second embodiment of the authenticity label 54, as shown in FIG. 4B, provides a tamper proof adhesive sticker that certifies the authenticity of the article and provides holographic images in the background which provide various phases such as “Security Valid” or “Authentic Genuine” to ensure that the customer is aware that they are purchasing an authentic beauty product from a salon retailer. This particular type of label can be used on various products for any number of salon retailers since the labels are not customized for each particular salon. If desired, these particular labels may be customized if preferred by the salon retailer in accordance with their requests and further may provide an authenticating logo or image.

As previously suggested, the authentication label may be manufactured in various size, shapes, colors, or configurations. One particular embodiment, provides a label having one adhesive side and an alternate side providing the image and text information. The adhesive used may include a type of adhesive surface which does not allow the label to be reapplied to other products once the label has been attached. The use of this type of adhesive ensures that the authenticity label is tamper proof. Additionally, the label may be configured with tabs or slits that cause the label to tear upon removal. The sizing of the label may be modified depending on the requirements of the packaging and product that it is attaching to. One embodiment provides a label that is 1″ wide by 1.5″ in height. Other preferred labels include those that are smaller in size and range from approximately 1″ wide to 0.5″ in height. The authenticity labels are designed to be noticeable by the consumer, and therefore often include a metallic background which will catch a consumer's eye. In general, the label may be configured and designed to include various features that ensure authenticity and convey the same to the consumers. Moreover, the description, the sizing or configuration o the authenticity notification on the label is no way intended to limit the label.

The location of the label relative to the product may vary depending on the packaging of the product. Particularly, the label may be positioned to straddle the lid and the body of the container, thereby resulting in the label being torn upon the opening of the package. If the package is a self-contained unit that does not require opening, the label may be placed in a position that is readily visible to the consumer. Furthermore, if the product has packaging that includes a flip-top, the tamper proof sticker may be applied so that it will have to be broken in order to open the packaging or flipping the lid of the container. Various positioning of the label may be used and the provided description is in no way intended to limit the placement of the label on the beauty product but instead operates to provide examples of various embodiments of label positioning.

As previously described, various sales and advertising information may be provided to the salon retailers to display throughout their establishments in order to inform consumers that they are purchasing genuine beauty salon products. As seen in FIG. 5, posters, fliers, stickers and various brochures may be designed to reflect a designated message that reassures the consumer that they are purchasing authentic beauty products. Similar to FIG. 4A which provides a similar message to on an authenticity label, the provided brochure used to advertise to consumers in order to ensure that the consumer is well informed about the products that they are purchasing.

Although the present invention provides a method for ensuring the authenticity of a beauty products throughout the stream of commerce and into the marketplace, this type of method may be applied in other industries that require the certification of authenticity of products. While the invention has been particularly shown and described to the preferred embodiments thereof, it is well understood by those skilled in the art that various changes and modifications can be made in the invention without departing from the spirit and scope of the invention.

1. A method for ensuring the authenticity of beauty products comprising the steps of:
receiving a beauty product for distribution within a marketplace;
authenticating said beauty product in order ensure that a genuine beauty product is being distributed into the marketplace;
applying an authenticity label to said authenticated beauty product; and
providing said authenticated beauty product having said authenticity label to a retailer for sale to a consumer.

2. The method according to claim 1 wherein said step of receiving further comprises receiving a beauty product from an original manufacturing company.

3. The method according to claim 1 wherein said distribution of said beauty product further includes the steps of packaging and labeling the beauty product for distribution to a retailer.

4. The method according to claim 1 wherein said retailer is a beauty salon.

5. The method according to claim 1 wherein said beauty product is intended for retail salons only.

6. The method according to claim 1 further comprising the step of providing corresponding sales literature to said retailer for advertising the authenticity of the beauty product.

7. The method according to claim 1 wherein authenticity label is an adhesive tamper proof sticker.

8. The method according to claim 6 further including customizing the authenticity label to incorporate a design to reflect a particular retailer.

9. The method according to claim 6 wherein said tamper proof sticker further includes a plurality of slits that result in the sticker being torn upon removal from the beauty product.

10. The method according to claim 5 wherein said sales literature further includes posters, brochures, fliers, display panels, stickers, and combinations thereof.

11. The method according to claim 1 wherein said authenticity label further includes a type of contact information in order for the consumer to notify the distributor if the beauty product has been tampered with.

12. A method for ensuring the authenticity of beauty products wherein said method comprising the steps of:
receiving a beauty product in a bulk quantity for distribution into the marketplace;
authenticating said beauty product in order ensure that a genuine beauty product is being distributed into the marketplace;
packing said authenticated beauty product into individual packaging;
preparing corresponding authenticity labels to be applied to the beauty products within individual packaging;
providing said individually packaged authenticated beauty products and corresponding authenticity labels to the retailer for application to of authenticity labels to said individually packaged beauty products for sale to a consumer.

13. The method according to claim 12 wherein said retailer is a beauty salon.

14. The method according to claim 12 further including the step of providing corresponding sales literature to said retailer for advertising the authenticity of the beauty product.

15. The method according to claim 12 wherein said authenticity label is customized to reflect a logo of the retailer.

16. The method according to claim 12 wherein said authenticity label is an adhesive tamper proof sticker.

17. A method for ensuring the authenticity of beauty products wherein said method comprising the steps of:
receiving a beauty product for distribution into the marketplace;
authenticating said beauty product in order ensure that an a genuine beauty product is being distributed into the marketplace;
providing said authenticated beauty product to a retailer for distribution to the consumer;
providing authenticity labels to said retailer in order for the retailer to directly apply the authenticity labels to said beauty product.

18. The method according to claim 17 further comprising the step of providing corresponding sales literature from the distributor to said retailer for advertising the authenticity of the beauty product.

19. The method according to claim 17 wherein said retailer is a beauty salon.

20. The method according to claim 17 wherein said authenticity label is an adhesive tamper proof sticker.
